(19) United States
(12) Patent Application Publication
(10) Pub. No.: US 2013/0009017 A1
(43) Pub. Date: Jan. 10, 2013

(54) ELECTRONICALLY SYNCHRONIZED FLAP SYSTEM

(75) Inventors: Andrew Thompson, Ada, MI (US); Jeffrey A. Baker, Zeeland, MI (US); John D. Neely, Kentwood, MI (US); Peter A. Torres, Plainwell, MI (US)

(73) Assignee: EATON CORPORATION, Cleveland, OH (US)

(21) Appl. No.: 13/532,926

(22) Filed: Jun. 26, 2012

Related U.S. Application Data
(60) Provisional application No. 61/504,901, filed on Jul. 6, 2011.

(51) Int. Cl. B64C 3/50

(52) U.S. Cl. 244/213

(57) ABSTRACT

An electronically-synchronized flap system for a fixed-wing aircraft including a first wing including a first flap panel, the first flap panel being connected with a first in-board actuator and a first out-board actuator, and a second wing including a second flap panel, the second flap panel being connected with a second in-board actuator and a second out-board actuator. In an embodiment, the system can further include an electronic control unit (ECU) configured to control the first and second in-board and out-board actuators to electronically synchronize the positions of the first and second flap panels.

### CROSS-REFERENCE TO RELATED APPLICATION

The present disclosure claims priority to U.S. provisional application No. 61/504,901, filed Jul. 6, 2011, which is hereby incorporated by reference in its entirety.

### BACKGROUND

1. Technical Field

The present disclosure relates generally to aircraft flap systems, including electronically-synchronized flap systems for fixed-wing aircraft.

2. Description of the Related Art

One known type of fixed-wing aircraft flap system is a fully distributed fly-by-wire flap system. In such a system, each flap actuator—for example, an in-board actuator and an out-board actuator for the left wing, and an in-board actuator and an out-board actuator for the right wing—may be independently positioned and actuated, without any interconnection. As a result, the positions of the actuators, and thus of the flap panels, may be difficult to consistently synchronize.

One conventional solution for synchronizing the positions of flap actuators is embodied in the system 10 shown in FIG. 1. The conventional system 10 relies, generally, on mechanical synchronization of the flap panel actuators. The conventional system 10 can include a flap panel position input 12 using a data and signal communications path 13 to communicate with a flap electronic control unit (ECU) 14, a motor/brake 16, and a power distribution unit (PDU) 18. In the left wing 20, the conventional system 10 can include a left flap panel 22, a left in-board actuator 24, a left out-board actuator 26, and a number of flap position sensors 28. The right wing 30 similarly can include a right flap panel 32, a right in-board actuator 34, a right out-board actuator 36, and a number of flap position sensors 38. For visual clarity, not all position sensors 28, 38 are designated.

In the conventional system 10, the common motor/brake 16 can provide power for actuators 24, 26, 34, 36 in the left wing and right wing, which can be distributed by the PDU 18 to the respective actuators. To distribute power, a mechanical transmission system, such as a series of rotatable flexible torque shafts or torque tubes 40, couples the PDU 18 to the in-board actuators 24, 34 in each wing. Another mechanical transmission, such as flexible shafts or torque tubes 42, couple each in-board actuator 24, 34 with a respective out-board actuator 26, 36. Thus, a single motor/brake 16 and single PDU 18 drive both flap panels 22, 32 through mechanical transmissions 40, 42.

Because a single, central motor/brake 16 and a single, central PDU 18 are used to provide power to flap actuators in both wings, the transmissions 40, 42 can be large and heavy. Furthermore, the single large PDU 18 can be inefficient. As a result, conventional systems may often be comparatively heavier and less efficient.

### SUMMARY

In an embodiment, a flap system that can be comparatively more efficient and lighter in weight than conventional flap systems may be configured to be electronically synchronized from left wing panel to right wing panel and may be mechanically synchronized (e.g., connected) between the in-board and out-board actuators on the same panel. An embodiment of such a system can include a first flap panel in a first wing, a second flap panel in a second wing, and an electronic control unit (ECU). The first flap panel can be connected with a first in-board actuator and a first out-board actuator, and the second flap panel can be connected with a second in-board actuator and a second out-board actuator. The ECU can be configured to control the first and second in-board and out-board actuators to electronically synchronize the positions of the first and second flap panels.

Another embodiment of a flap system may include some of the aforementioned features and may provide similar advantages. Such embodiments can include a first flap panel in a first wing, a second flap panel in a second wing, a first motor, and second motor, and an ECU. The first flap panel and the first motor can be connected with a first actuator, and the second flap panel and the second motor can be connected with a second actuator. The ECU can be configured to control the first and second motors to electronically synchronize the positions of the first and second flap panels.

Still another embodiment of a flap system may include some of the aforementioned features and may provide similar advantages, and may include a first flap panel in a first wing, a second flap panel in a second wing, a first single motor for actuating the first flap panel, and a second single motor for actuating the second flap panel. The system can further include an ECU configured to control the first and second motors to electronically synchronize the positions of the first and second flap panels.

### BRIEF DESCRIPTION OF THE DRAWINGS

Embodiments of the invention will now be described, by way of example, with reference to the accompanying drawings, wherein:

FIG. 1 generally illustrates a conventional flap system.

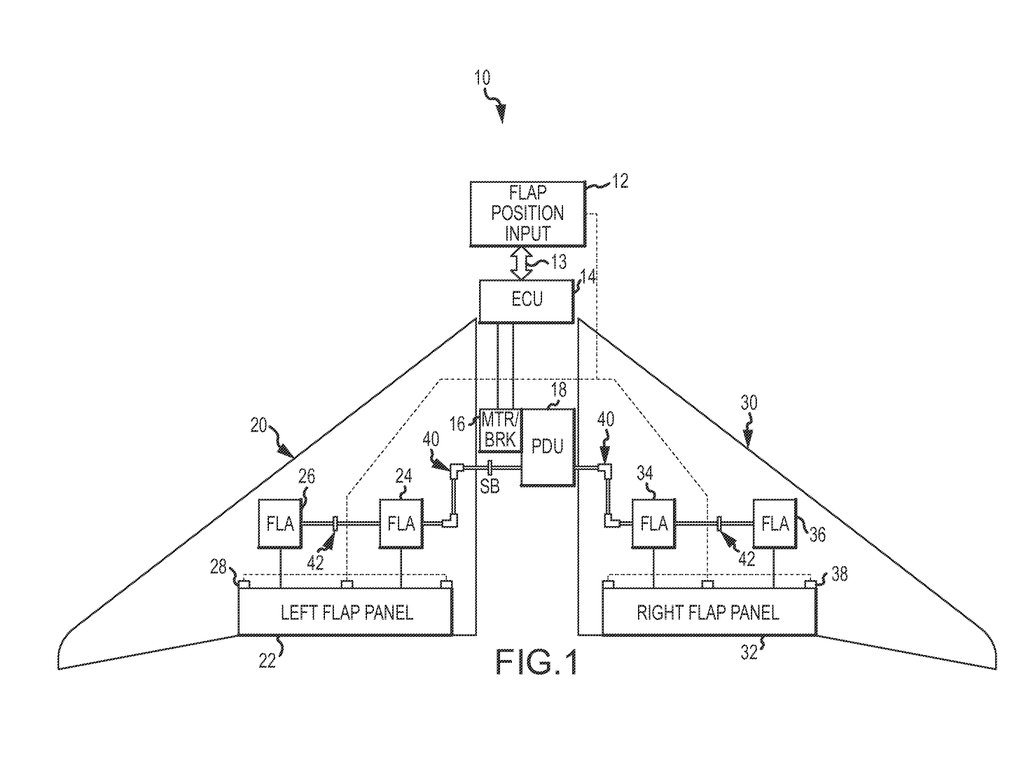

FIG. 2 generally illustrates an embodiment of an electronically-synchronized flap system.

FIG. 3 generally illustrates another embodiment of an electronically-synchronized flap system.

### DETAILED DESCRIPTION

Reference will now be made in detail to embodiments of the present invention, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined by the appended claims.

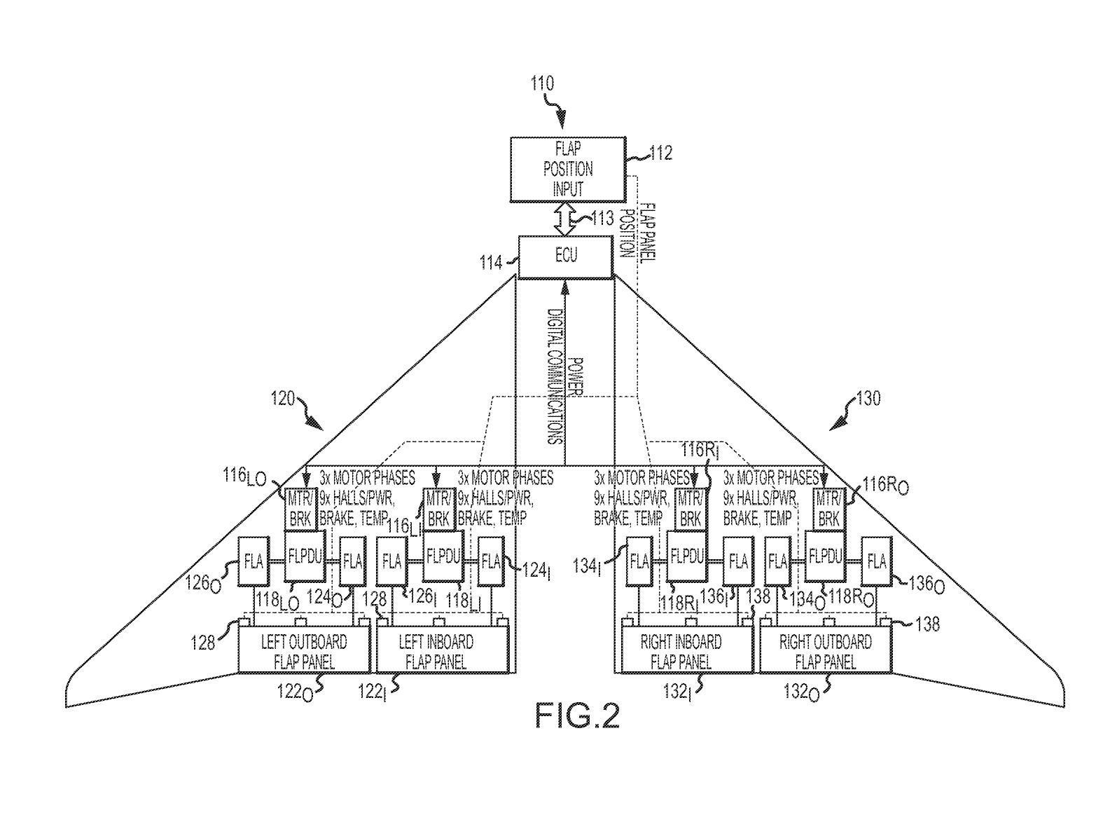

An embodiment of an electronically-synchronized flap system is generally illustrated in FIG. 2. The first electronically-synchronized system 110 can include a flap panel position input 112 using a data and signal communications path 113 to communicate with a flap electronic control unit (ECU) 114. In the left wing 120, the first electronically-synchronized system 110 can further include inboard and outboard left flap panels 122_{I}, 122_{O}, inboard and outboard flap panel actuators 124_{I}, 126_{I} for the left inboard flap panel 122_{I}, inboard and outboard flap panel actuators 124_{O}, 126_{O} for the left outboard flap panel 122_{O}, inboard and outboard motor/brakes 116_{LI}, 116_{LO}, inboard and outboard power distribution units (PDU) 118_{LI}, 118_{LO}, and a number of flap position sensors 128. The right wing 130 similarly can include inboard and outboard right flap panels 132_{I}, 132_{O}, inboard and outboard flap panel actuators 134_{I}, 136_{I} for the right inboard flap panel 132_{I}, inboard and outboard flap panel actuators 134_{O}, 136_{O} for the right outboard flap panel 132_{O}, inboard and outboard motor/brakes 116_{RI}, 116_{RO}, inboard and outboard PDUs 118_{RI}, 118_{RO}, and a number of flap position sensors 138. For visual clarity, not all flap position sensors 128, 138 are designated. It should be understood that although multiple flap panels are illustrated for each wing, the synchronized flap systems described herein can also apply to an aircraft with a single flap panel in each wing.

The flap panel position input 112 can be any apparatus known in the art for commanding the position of one or more flap panels. In an embodiment, the flap panel position input can be, for example, a flight control computer or a flap handle. The flap panel input can issue flap panel commands over the data and signal communications path 113. In an embodiment, the data and signal communications path may operate according to ARINC 825 or another appropriate communications protocol.

The ECU 114 can be configured to receive commands from a user/pilot, for example, through the flap panel position input 112, and to transmit or translate those commands into a position or movement of one or all of the flap panels 122, 132. To convert commands into movement of the flap panels 122, 132, the ECU 114 can include hardware and/or software-based control (e.g., in the form of algorithms or code) for transmitting or translating user/pilot commands into flap panel control. In an embodiment, the ECU 114 and other components in the system 110 can receive power from a 28 volt DC power source for generating control and communication signals.

To move the flap panels 122, 132, the ECU 114 can issue commands to each motor/brake 116 coupled with each flap panel 122, 132. Power from each motor/brake 116, in turn, can be distributed to the in-board actuators 124, 134 and out-board actuators 126, 136 coupled with each flap panel by the PDUs 118 associated with each flap panel, each of which may also be connected to a respective motor/brake 116. Because the actuators 124, 126, 134, 136 can be connected to the flap panels 122, 132, movement of the actuators may result in corresponding movement of the flap panels. For example, the ECU 114 can be configured to control each motor/brake 116 and PDU 118 with a set or prescribed velocity and a direction (e.g., extend or retract) to extend or retract the flap panels 122, 132. In an embodiment, each motor/brake 116 and PDU 118 may receive power from a 115 volt AC power source.

Each motor/brake 116 can include a motor configured to provide power to the flap actuators 124, 126, 134, 136 for moving a respective one of the flap panels 122, 132 and a brake for preventing such movement (i.e., for slowing the movement of or locking the position of the flap panel). It should be understood that, though shown as unitary, the motor and brake portions of a motor/brake 116 can be physically separate components. In embodiments, a single motor and brake may be provided for each wing or flap panel or, alternatively, more than one motor/brake per wing or flap panel may be provided. In embodiments, each motor/brake 116 can comprise various acceptable devices or apparatus known in the art that are suitable for such an application.

In an embodiment, a PDU 118 can be provided in each wing or for each flap panel for distributing power from the motor/brake 116 to the associated flap actuators 124, 126, 134, 136. Each PDU 118 can be provided between, and connected to, respective in-board 124, 134 and out-board actuators 126, 136 for a flap panel, and can be further connected to the motor/brake 116 in that wing. The PDU 118 can be configured to rotate at a velocity and in a direction provided or relayed by the ECU 114. With embodiments, the PDU 118 may be configured to cause or initiate the rotation of torque tubes and/or flexing shafts connected to the in-board and out-board actuators—for example, to cause the actuators 124, 126, 134, 136 to rotate, extend, or retract to extend or retract the flap panels 122, 132. Through the use of such torque tubes or flex shafts, each PDU 118 can be configured to mechanically synchronize movement of the in-board and out-board actuators for a single flap panel.

As noted above, proper in-flight operation requires that the left and right flap panels 122, 132 move in a form of synchronization. For this and other reasons, one or more position sensors 128, 138 can be connected to the left and right flap panels 122, 132 and can be configured to sense and/or measure the positions of the flap panels 122, 132. The ECU 114 can be operatively (e.g., electrically) connected with the positions sensors 128, 138 for monitoring the position of one or more portions of the flap panels 122, 132. Such a coupling may be indirect, such as through the flap position input 112, for example, or may be direct. Using position data or measurements, the ECU 114 can, for example, be configured to determine asymmetry of the flap panels 122, 132 relative to each other, as well as skew of a single flap panel. The ECU 114 can also monitor the flap panels 122, 132, such as, for example, uncommanded/unintentional movement, or for failure to move when commanded, using feedback from the position sensors 128, 138. In an embodiment, the position sensors 128, 138 can be, for example and without limitation, various position sensors known in the field for similar applications. Multiple different types of position sensors 128, 138 may be used in a single aircraft or wing or, alternatively, all position sensors 128, 138 may be of the same type.

The ECU 114 can compare, for example and without limitation, skew, asymmetry, uncommanded/unintentional movement, and/or failed commanded movement to predetermined thresholds associated with failure states of the flap panels 122, 132. The system may be configured so that in the event that readings from the position sensors 128 indicate that a failure state has occurred—i.e., that asymmetry, skew, and/or uncommanded/unintentional motion is approaching or is beyond a threshold—the ECU 114 can, for example, shut down (i.e., lock) the flap panels 122, 132 via brakes (e.g., motor/brake 116) to help ensure safety and reliability. In an embodiment, the ECU 114 may be configured to signal or command the motor/brakes 116 to correct for some amount of asymmetry or skew.

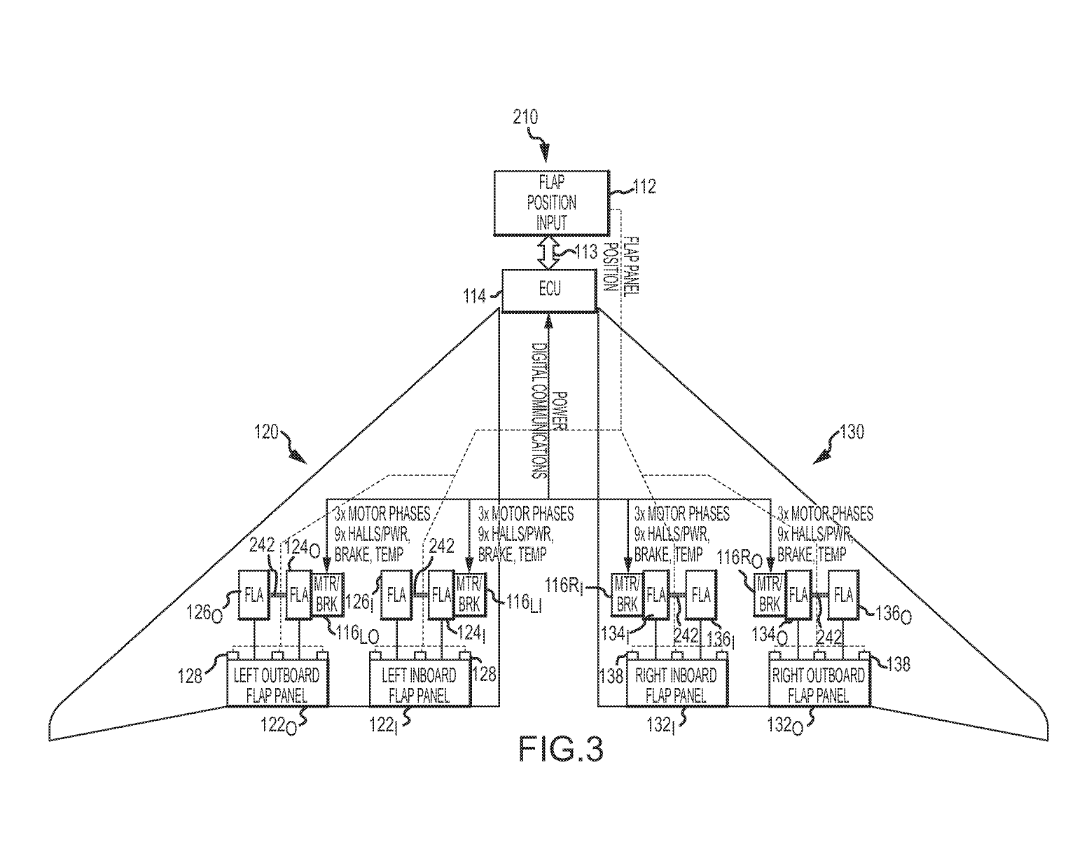

Another embodiment of an electronically-synchronized flap system 210 is generally illustrated in FIG. 3. The illustrated system 210 is similar to the first system 110 in that the flap panels in both systems 110, 210 are configured to be electronically synchronized. Except as otherwise indicated, the components of system 210 operate in substantially the same manner as similar components associated with system 110.

The illustrated system 210 may include a flap panel position input 112 using a data and signal communications path 113 to communicate with a flap ECU 114. In the left wing 120, the second electronically-synchronized system 210 can further include inboard and outboard left flap panels 122_{I}, 122_{O}, inboard and outboard flap panel actuators 124_{I}, 126_{I} for the left inboard flap panel 122_{I}, inboard and outboard flap panel actuators 124_{O}, 126_{O} for the left outboard flap panel 122_{O}, inboard and outboard motor/brakes 116_{LI}, 116_{LO}, inboard and outboard power distribution units (PDU) 118_{LI}, 118_{LO}, and a number of flap position sensors 128. The right wing 130 similarly can include inboard and outboard right flap panels 132_{I}, 132_{O}, inboard and outboard flap panel actuators 134_{I}, 136_{I} for the right inboard flap panel 132_{I}, inboard and outboard flap panel actuators 134_{O}, 136_{O} for the right outboard flap panel 132_{O}, inboard and outboard motor/brakes 116_{RI}, 116_{RO}, inboard and outboard PDUs 118_{RI}, 118_{RO}, and a number of flap position sensors 138. For visual clarity, not all flap position sensors 128, 138 are designated.

In the illustrated system 210, the ECU 114 can issue or transmit commands to the motor/brake 116 in each wing to move the flap panels 122, 132. Each motor/brake 116 can be connected to an in-board actuator 124, 134. The in-board actuators 124, 134 can respectively be connected to the out-board actuators 126, 136 through a mechanical transmission, such as torque tubes or flex tubes 242. In an embodiment, each in-board actuator 124, 134 can comprise a PDU configured to distribute power to the out-board actuators 126, 136. As a result, connected in-board and out-board actuators can be moved by a single motor/brake 116 in a mechanically-synchronized manner.

As in system 110, the ECU 114 associated with system 210 can be configured to synchronize the movement and positions of the left and right flap panels 122, 132. Accordingly, the ECU 114 can be configured to receive movement instructions or commands—e.g., to command the movement of flaps to a position—from a pilot through a flap selector lever or a flight control system, such as the flap position input 112, for example. The ECU 114 can be configured, e.g., through control parameters or algorithms, to control the motor portion of each motor/brake 116, such as with respect to velocity and direction (e.g., extend or retract) along with the brake portion of each motor/brake 116. In an embodiment, each motor/brake 116 may be configured to drive a gear train and interconnected transmission shafting 242 to control movement of both an in-board and out-board actuator 124, 126, 134, 136, and associated movement of each flap panel 122, 132. The position of the actuator 124, 126, 134, 136 or motor/brake 116 can electronically synchronize each of the flap panels 122_{I}, 122_{O}, 132_{I}, 132_{O} with each other through control laws or parameters associated with (e.g., executed by) the ECU 114.

Position feedback for closed-loop position control may be provided by the flap position sensors 128, 138 that can be configured to monitor the panels. In an embodiment, the flap position sensors 128, 138 within a single wing or coupled with a single flap panel can be independent from each other and redundant. Based on feedback from the position sensors 128, 138, the ECU 114 can, for example and without limitation, check for asymmetry, skew, uncommanded/unintentional movement, and/or failed commanded movement of the flap panels 122, 132. The ECU 114 can compare skew, asymmetry, uncommanded/unintentional movement, and/or failed commanded movement to predetermined thresholds associated with failure states of the flap panels 122, 132. In the event that readings from the position sensors 128 indicate that a failure state has occurred—i.e., that asymmetry, skew, or uncommanded/unintended motion is approaching or is beyond a threshold—the ECU 114 can be configured to shut down (i.e., lock) the flap panels 122, 132 via brakes (e.g., motor/brake 116) to help ensure safety and reliability. In an embodiment, the ECU 114 may be configured to command the motor/brakes 116 to correct asymmetry or skew, if possible.

Electronically-synchronized flap systems 110, 210 such as those generally described herein can provide a number of advantages with respect to known flap systems. Because each wing or flap panel can be configured to include its own motor/brake 116 (and, in some embodiments, its own PDU 118), the need for a large and inefficient centralized PDU, interconnection gear boxes, centralized torque transmission tubes/flex shafts and related support bearings associated with some conventional systems can be reduced or eliminated. As a result, the systems 110, 210 can have much lower weight and higher efficiency than a conventional system and may be simpler to install and maintain. In addition, the presence of an independent motor/brake in each wing or for each flap panel can allow the ECU 114 to correct minor skew across the position of one or more of the left and right flap panels 122, 132 and asymmetry between the positions of one or more of the left and right flap panels 122_{I}, 122_{O}, 132_{I}, 132_{O}.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims and their equivalents.

What is claimed:

1. A flap system for an aircraft, comprising:
a first wing including a first flap panel, the first flap panel connected with a first in-board actuator and a first out-board actuator;
a second wing including a second flap panel, the second flap panel connected with a second in-board actuator and a second out-board actuator;
an electronic control unit (ECU) configured to control the first and second in-board and out-board actuators to electronically synchronize the positions of the first and second flap panels.

2. The flap system of claim 1, further comprising:
a first power distribution unit disposed between and connected to the first in-board actuator and the first out-board actuator; and
a second power distribution unit disposed between and connected to the second in-board actuator and the second out-board actuator,
wherein the ECU drives the first and second power distribution units to control the first and second in-board and out-board actuators.

3. The flap system of claim 2, further comprising:
a first motor connected to the first power distribution unit; and
a second motor connected to the second power distribution unit,
wherein the ECU controls the first and second motors to drive the first and second power distribution units.

4. The flap system of claim 1, further comprising:
a first motor connected to the first in-board actuator and connected to the first out-board actuator through a first transmission; and
a second motor connected to the second in-board actuator and connected to the second out-board actuator through a second transmission,
wherein the ECU drives the first and second motors to control the first and second in-board and out-board actuators.

5. The flap system of claim 1, further comprising:
a first position sensor configured to measure the position of the first flap panel; and
a second position sensor configured to measure the position of the second flap panel.

6. The flap system of claim 5, wherein the ECU is configured to monitor the respective positions of the first and second flap panels according to output from the first and second position sensors.

7. The flap system of claim 6, wherein the ECU is configured to lock the respective positions of the first and second flap panels if the respective positions of the first or second flap panels indicate a failure state.

8. The flap system of claim 7, wherein the failure state comprises one or more of asymmetry between the positions of the first and second flap panels, skew across the position of at least one of the first and second flap panels, and uncommanded motion of the first flap panel or the second flap panel.

9. The flap system of claim 1, further comprising:
a first brake connected with the first flap panel; and
a second brake connected with the second flap panel.

10. The flap system of claim 1, wherein each wing includes a plurality of flap panels, each flap panel connected with a respective in-board actuator and a respective out-board actuator.

11. A flap system for an aircraft, comprising:
a first wing including a first flap panel, the first flap panel being connected with a first actuator;
a second wing including a second flap panel, the second flap panel being connected with a second actuator;
a first motor, connected with the first actuator;
a second motor, connected with the second actuator; and
an electronic control unit (ECU) configured to control the first and second motors to electronically synchronize the positions of the first and second flap panels.

12. The flap system of claim 11, wherein the first actuator comprises a first in-board actuator and a first out-board actuator and the second actuator comprises a second in-board actuator and a second out-board actuator.

13. The flap system of claim 12, wherein the first motor is disposed between the first in-board actuator and the first out-board actuator and the second motor is disposed between the second in-board actuator and the second out-board actuator.

14. The flap system of claim 12, further comprising:
a first power distribution unit configured to distribute power from the first motor to the first in-board actuator and the first out-board actuator; and
a second power distribution unit configured to distribute power from the second motor to the second in-board actuator and the second out-board actuator.

15. The flap system of claim 12, wherein the first in-board actuator is mechanically connected with the first out-board actuator, and the second in-board actuator is mechanically connected with the second out-board actuator.

16. The flap system of claim 11, further comprising:
a first brake connected with the first flap panel; and
a second brake connected with the second flap panel.

17. A flap system for an aircraft, comprising:
a first wing including a first flap panel;
a second wing including a second flap panel;
a first single motor for actuating the first flap panel;
a second single motor for actuating the second flap panel; and
an electronic control unit (ECU) configured to control the first and second motors to electronically synchronize the positions of the first and second flap panels.

18. The flap system of claim 17, further comprising:
a first in-board actuator in the first wing connected to the first flap panel and the first motor;
a first out-board actuator in the first wing connected to the first flap panel and the first motor;
a second in-board actuator in the first wing connected to the second flap panel and the second motor; and
a second out-board actuator in the first wing connected to the second flap panel and the second motor.

19. The flap system of claim 18, wherein the first motor is connected to the first in-board actuator and is further connected to the first out-board actuator through a first transmission, further wherein the second motor is connected to the second in-board actuator and is further connected to the second out-board actuator through a second transmission.

20. The flap system of claim 18, further comprising:
a first power distribution unit connected to the first motor and disposed between and connected to the first in-board actuator and the first out-board actuator; and
a second power distribution unit connected to the second motor and disposed between and connected to the second in-board actuator and the second out-board actuator.

21. The flap system of claim 17, further comprising:
a first single brake connected to the first flap panel; and
a second single brake connected to the second flap panel.
